(19) United States
(12) Patent Application Publication
(10) Pub. No.: US 2016/0181912 A1
(43) Pub. Date: Jun. 23, 2016

(54) REGULATION FOR MULTI-PHASE VOLTAGE PUMP SYSTEM

(71) Applicant: International Business Machines Corporation, Armonk, NY (US)

(72) Inventors: Darren L. Anand, Williston, VT (US); John A. Fifield, Underhill, VT (US)

(21) Appl. No.: 14/573,745

(22) Filed: Dec. 17, 2014

(51) Int. Cl. H02M 3/07

(52) U.S. Cl. CPC H02M 3/07

(57) ABSTRACT

An approach of operating a voltage pump system for a semiconductor chip. The approach includes one or more voltage pumps receiving a pair of clock signal inputs. The approach includes activating a first group of voltage pumps with a high clock signal level and activating a second group of voltage pumps activate with a low clock signal level. Furthermore, the approach includes deriving the pair of clock signal inputs from an oscillator and a hold circuit and configuring a current clock signal output level to latch upon receipt of a hold signal.

### BACKGROUND

The present invention relates generally to the field of semiconductor technology, and more particularly to voltage pump system regulation and architecture.

Voltage multiplier circuits which may be called “pump” or “boost” circuits use a supply voltage as an input to generate a multiplied power supply level. Voltage multiplier circuits may be used in embedded dynamic random access memory (eDRAM), flash memory, and other integrated circuits. In eDRAM, voltage multiplier circuits or voltage pump systems may generate array voltages above supply voltage and below ground voltage using a voltage multiplier to generate boosted voltages. The voltage pump systems may be enabled or disabled to regulate the boosted voltage supply to a target voltage level by use of a regulating circuit to gate an oscillating signal driving the voltage pumps. A multi-phase system may be used wherein an oscillator signal is divided into four clocks, each separated by 90-degrees. A rising or falling edge occurs every 90-degrees which defines an active period for each of the four voltage pumps. In this system, half of the voltage pumps activate when a clock is high, and the other half of the voltage pumps activate when the clock is low.

Commonly, oscillator signals are gated off when a voltage regulator detects the boosted voltage level, Vpp for example, has met the reference or compliance voltage level. In some cases, this is done by gating the oscillator signal for a clock through a “negated AND” or “NOT AND” logic gate (NAND gate) where the gated clock signal will go to a “0” in the “off” state. Although the “0” or pump-off signal from the voltage regulator halts the clock signals from running the voltage pumps, an inadvertent final activation of half the voltage pumps occurs once as the NAND gate forces the gated clock signal to a “0”, or “off” state. An overshoot of the voltage pump voltage above the reference voltage level due to the inadvertent activation of half the voltage pumps complicates voltage pump regulation and may cause increases in peak to peak ripple current, a small unwanted residual periodic variation of the direct current output derived from an alternating current source.

### SUMMARY

Embodiments of the present invention provide a method of operating a voltage pump system for a semiconductor chip. The method including one or more voltage pumps receiving a pair of clock signal inputs. The method includes activating a first group of voltage pumps with a high clock signal level and activating a second group of voltage pumps with a low clock signal level. Furthermore, the method includes deriving the pair of clock signal inputs from an oscillator and a hold circuit and configuring a current clock signal output level to latch upon receipt of a hold signal.

Additionally, embodiments of the present invention provide a multiple phase voltage pump system including a four phase voltage pump system with a 2× frequency oscillator having a pair of oscillator signals 180-degrees out of phase. The system includes the pair of oscillator signals coupled to a pair of divide by two D-latch circuits and the pair of divide by two D-latch circuits each output a clock signal to a pair of pump phase generators. Furthermore, the system includes the pair of pump phase generators to produce four 1× frequency clock signals where the four 1× frequency clocks signals are 90 degrees out of phase with each other. Additionally, the system includes a voltage regulator determining a hold signal and one or more voltage pumps each having a voltage pump activation state and a voltage pump disable state. Lastly, the system includes that the pump disable state occurs when the voltage regulator determines a high level hold signal.

### BRIEF DESCRIPTION OF THE DRAWINGS

FIG. 1 is a block diagram depicting a configuration of a voltage pump regulation circuit for a multi-phase voltage pump system in accordance with an embodiment of the present invention.

FIG. 2 is an illustration of a timing chart for a voltage regulator circuit with two oscillator signals operating at ninety degrees apart in accordance with an embodiment of the present invention.

FIG. 3 is a schematic diagram of one hold circuit of the hold circuits depicted in FIG. 1, in accordance with an embodiment of the present invention.

FIG. 4 is an illustration of a waveform plot using the hold circuit of FIGS. 1 and 3, in accordance with an embodiment of the present invention.

### DETAILED DESCRIPTION

Embodiments of the present invention recognize that voltage multiplier circuits using voltage pump systems commonly include a regulator circuit to an oscillator signal which is gated to enable or disable the voltage pump system in a multiphase system. When the boosted voltage level of the multiplier circuit reaches a compliance level and oscillator signals are gated, through a NAND gate, for example, the gated signal goes to an “off” state and voltage pumps are halted. However, a final pump stroke, or an activation state or activation period of half the voltage pumps is executed as the NAND gates transition to an “off” state.

Embodiments of the present invention provide a voltage pump architecture in which the voltage pump system is disabled when a compliance or reference voltage has been reached, and that does not appreciably boost voltage above the compliance or reference voltage level or execute additional pump strokes once the reference voltage level is met. The voltage pump architecture includes a voltage regulator, a hold circuit configured to divide an incoming oscillator signal by two, an oscillator and two blocks of voltage pumps. The voltage regulator outputs a hold pump (HOLDP) signal such that when the boosted voltage supply level, Vpp, meets or is equal to the reference voltage (i.e. REF), a high level of the HOLDP signal is output to each of the hold circuits controlling the voltage pumps in the blocks of voltage pumps. The high level HOLDP signal freezes or latches the clock outputs such that the clock signals remain in the existing state, either an existing high state or an existing low state. Embodiments of the present invention prevent the initiation of additional pump strokes causing an overshoot of the boosted voltage level once the voltage compliance or reference voltage level is met and thereby, improving voltage regulation in the circuit.

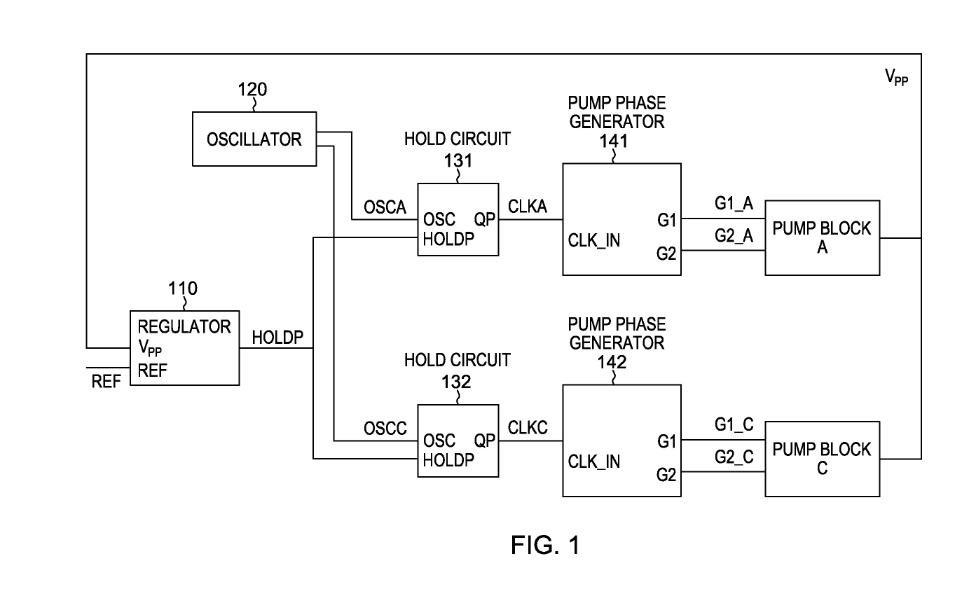

FIG. 1 is a block diagram depicting a configuration of a voltage pump regulation circuit for a multi-phase voltage pump system in accordance with an embodiment of the present invention. As depicted, FIG. 1 includes regulator 110, oscillator 120, hold circuits 131 and 132, pump phase generators 141 and 142, pump block A, and pump block C. The depicted multiphase voltage pump regulation architecture for a design of a four phase voltage pump system provides a hold function or a hold circuit to maintain, or “freeze”, at the same level, the clock circuits that drive the voltage pump system when a voltage regulator, regulator 110 detects that the incoming boosted voltage level, Vpp, is at the target or reference voltage level (i.e. REF in FIG. 1) for the circuit. Thus, without further changes to the clock signals driving the voltage pump system, no further activation of the pumps or a pump disable activation state occurs and no further increases in the boost voltage, Vpp, above the reference or target voltage level occur.

Regulator 110 which is a voltage regulator routinely samples boost voltage, Vpp, and compares Vpp to a reference or target voltage level (i.e. REF). When Vpp is below the reference voltage or below REF, regulator 110 outputs HOLDP at a low level or a low level signal (e.g. “0” or low level output for HOLDP) and the clock outputs of hold circuits 131 and 132 and, CLK A and CLK C respectively, continue to cycle with a pump activation state to drive pump block A and pump block C via pump phase generators 141 and 142. The reference voltage may be determined or set by a designer such as a circuit designer or a system designer. When the voltage regulator, regulator 110 determines Vpp attains or meets the reference voltage level (i.e. REF), regulator 110 outputs HOLDP at a high level or “1” and the hold circuits (i.e. hold circuits 131 and 132) are disabled and the clock outputs, CLK A and CLK C, remain at their current level. When the HOLDP signal is active or asserted at the high level, the CLK A and CLK C signals remain or are “frozen” at the levels present when Vpp reached the reference voltage level until Vpp drops below the reference voltage level.

Oscillator 120 outputs OSCA and OSCC signals which oscillate at a set frequency. In the exemplary embodiment, oscillator 120 runs at a 2× frequency or a frequency double the desired or configured clock frequency. For example, oscillator 120 signals OSCA and OSCC are 180-degrees out of phase and have a frequency of 2 GHZ, but are not limited to this frequency in other embodiments. The oscillator signals, OSCA and OSCC, connect to a pair of hold-circuits, respectively hold circuit 131 and hold circuit 132 which produce CLKA and CLKC signals, respectively, at 1 GHZ frequency. The pair of oscillator signals are coupled to a pair of divide by two D-latch circuits which include a toggle/hold function.

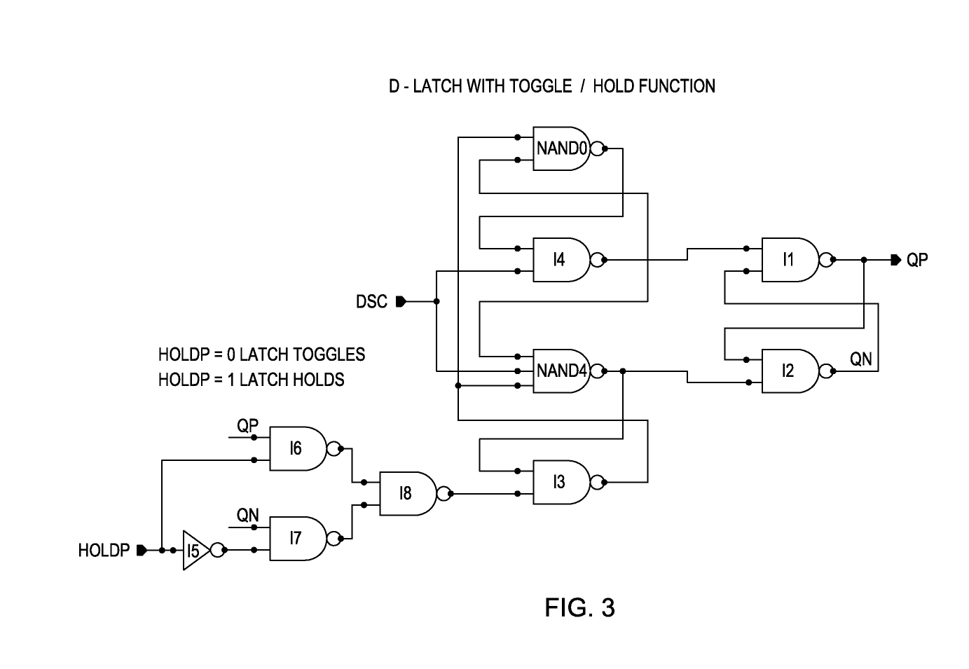

Hold circuits 131 and 132 operate as a conventional D-latch flip flop circuit with a toggle/hold function. Hold circuits 131 and 132 divide oscillator 120 signal in half with the toggle flip flop function and are described in more detail with reference to FIG. 3. Hold circuits 131 and 132 are configured to divide the incoming oscillator signal by 2 via the toggle flip flop function and output a clock signal half the frequency of the incoming oscillator signal. Hold circuits 131 and 132 receive from regulator 110 a HOLDP signal. Depicted inside hold circuits 131 and 132 in FIG. 1 may be a QP output (i.e. as depicted in FIG. 3) to make CLKA and CLKC. Hold circuit 131 outputs CLKA to pump phase generator 141 while hold circuit 132 outputs CLKC to pump phase generator 142. When the HOLDP signal received is at a high level or “1”, hold circuits 131 and 132 freeze or maintain CLK A and CLK C signal outputs to pump phase generators 141 and 142 at their existing or current level, respectively. In an embodiment, when a high level hold signal or HOLDP signal is received by a flip flop circuit in hold circuits 131 and 132, the flip flop circuit in hold circuits 131 and 132 latches a current clock signal level and prevents further pump strokes of the one or more voltage pumps when the voltage pump is in the voltage pump disable state. When the received HOLDP signal is at a low level or “0”, hold circuits 131 and 132 output clock signals, CLK A and CLK C, which cycle between low and high levels to pump phase generators 141 and 142, respectively. CLK A and CLK C signals drive pump phase generators 141 and 142 to each produce two “G” clock signals which in turn create a voltage pump activation state and respectively drive pump block A and pump block B. The activation of the voltage pumps in pump block A and pump block C produce boosted voltage, Vpp.

Pump phase generator 141 driven by the incoming clock signal, CLK A, produces voltage pump control clocks G1_A and G2_A which are 180-degrees out of phase. Similarly pump phase generator 142 receiving incoming clock signal, CLK C, produces voltage pump control clocks G1-C and G2_C which are also 180-degrees out of phase. According to conventional voltage pump system operation, the “G” clocks, G1_A, G2_A, G1_C, and G2_C activate the voltage pumps of pump block A and pump block C. The “G” clocks enable the pre-charge and the pump portions of the voltage operation of pump blocks A and C. A low logic level of a “G” clocks puts a pump in a restore or pre-charge mode whereas a high level or “1” state puts a pump in an active or stroke mode where it injects current into the boosted voltage net Vpp.

According to known methods in semiconductor voltage pump system design, the “G” clocks, G1_A, G2_A, G1_C, and G2_C, may be connected to one or more voltage pumps in pump block A and pump block C. In the exemplary embodiment, the “G” clocks are connected to a plurality of voltage pumps in pump block A and a plurality of voltage pumps in pump block C. In order to reduce the ripple on the boosted output voltage, Vpp, one half of the voltage pumps in pump block A activate in the first 180 degree of CLK A cycle while the other half of the voltage pumps in pump block A activate in the second 180 degree cycle of CLK A. The voltage pumps in pump block C operate in a similar manner with one half of the voltage pumps activating in the first 180 degree cycle of CLK C while the other half of the voltage pumps activate in the second 180 degree cycle of CLK C. Since CLK A and CLK C operate 90 degrees out of phase with each other, a multiphase or a four phase voltage pump system operates delivering a pump stroke every 90 degrees of the 2× frequency oscillator cycle.

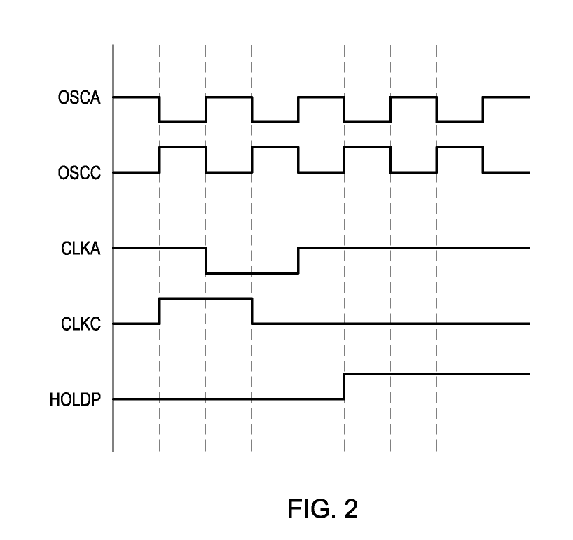

FIG. 2 is an illustration of a timing chart for a voltage regulator circuit with two oscillator signals operating at 180-degrees apart in accordance with an embodiment of the present invention. As depicted, FIG. 2 includes the waveforms and timing chart for HOLDP, OSC A, OSC C, CLK A, and CLK C. As illustrated, OSC A and OSC C operate at a frequency two times that of CLK A and CLK C. The oscillator has two outputs, OSC A and OSC C, operating 180 degrees out of phase with each other. In the four phase voltage pump system of FIG. 1, each oscillator output (i.e. OSC A and OSC C) is divided by a pair of two counters which produce clocks (i.e. CLK A and CLK C) operating at 1× frequency or desired frequency to provide an active-up and an active-down signal 90 degrees apart at 1× frequency as depicted as the square waveforms of CLK A and CLK C in FIG. 2. As depicted, a fixed phase interval of 90 degrees is established between voltage pump stages or pump strokes of the voltage pumps in the voltage pump system of FIG. 1 which is a digitally controlled time interval unaffected by process voltage or circuit temperature.

The hold signal, HOLDP, from regulator 110 in FIG. 1, is depicted in FIG. 2 in both a high and low state. When the signal generated by regulator 110 is in the low state or “0”, CLK A and CLK C run 90 degrees off phase. When the hold signal, HOLDP, from regulator 110 in FIG. 1, is in the high state or “1”, CLK A and CLK C are frozen or stopped in at their current or respective states (i.e. low level or high level) as depicted in FIG. 2. When HOLDP is in the high state or level, CLK A and CLK C are frozen or maintained at their current state (i.e. low or high) until regulator 110 in FIG. 1 determines that the boosted voltage, Vpp, drops below the reference voltage at which time HOLDP is dropped to its low state and CLK A and CLK C resume counting or cycling at a 1× frequency as depicted in FIG. 2. OSC A and OSC C continue to run at twice the frequency of CLK A and CLK C regardless of HOLDP state as depicted in FIG. 2. When CLK A and CLK C are frozen or held at the existing state, no further pumping will be initiated by the voltage pump system so some or one half the voltage pumps may remain in restore mode while the other half of the voltage pumps may be held or frozen while in an active mode (e.g. frozen without completing additional pump strokes).

FIG. 3 is a schematic diagram of one hold circuit of the hold circuits depicted in FIG. 1, in accordance with an embodiment of the present invention. As depicted, FIG. 3 includes a D-latch flip flop circuit with a toggle/hold function to construct a hold circuit such as hold circuits 131 and 132 in FIG. 1. The hold circuit with an edge triggered D-latch flip flop circuit using a toggle/hold function includes an inverter gate, 15 receiving input from HOLDP (generated by regulator 110 in FIG. 1) and outputting QN to a NAND gate, 17, NAND gate, 16 receives an input from HOLDP and QP while NAND gates, 16 and 17 connect to NAND gate 18 which connects to NAND gate, 13 an input into the D-Latch flip flop function. When HOLDP input or signal is at a high level or “1” to the circuit elements (NAND gates I5, I6, I7, and I8), the circuit is latched or holds at the current state. CLK A and CLK C of FIG. 1 and FIG. 2 remain fixed at their current levels and do not drive the voltage pumps to boost the voltage. When HOLDP input or signal is at a low level or “0” to the same circuit elements (i.e. I5, I6, I7 and I8), then the latch will toggle and CLK A and CLK C are re-enabled and begin to cycle at 90 degrees out of phase activating the voltage pumps to boost voltage Vpp until the reference voltage is again attained and HOLDP reverts back to its high level latching and holding CLK A and CLK C again.

The D-latch circuit receives input from OSC in addition to a toggle/hold input through I8. The latch portion is constructed with NAND gates I3, NAND4, I4, NAND0, I2, and I1 where I2 outputs QN and I1 outputs QP where output QP, as known in the art, is a “true” output, and output QN is a “complimentary” or inverted output of QP (i.e. when QP output=1, then, QN output=0). As is known to one skilled in the art, some logic designs use a QP output and a QN output in some versions of a D-latch circuit, for the exemplary embodiment of the present invention, QN output is not used but, a QN signal is used inside the D-latch circuit as an input at 16 to the hold circuit.

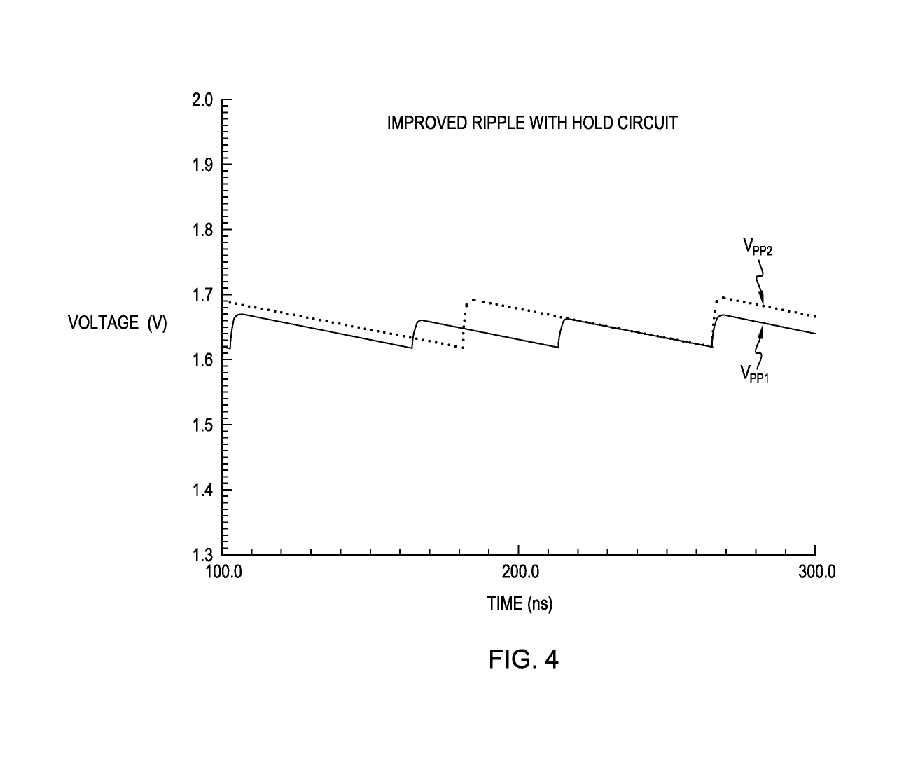

FIG. 4 is an illustration of a waveform plot using the hold circuit of FIGS. 1 and 3, in accordance with an embodiment of the present invention. As depicted, FIG. 4 includes modelled data of the boost voltage, Vpp1, for the exemplary embodiment of the present invention using a hold circuit, modelled data of the boost voltage, Vpp2, according to known methods in the art using gated oscillator signals to halt voltage pumps. The vertical axis is voltage in volts and the horizontal axis is time in nanoseconds (ns). The target voltage or reference voltage in this model is 1.65 V. As depicted in FIG. 4, the ripple current as modelled for an embodiment of the present invention using the hold circuit of FIGS. 1 and 3 provides a smaller ripple voltage and less resulting boosted voltage above desired reference voltage.

In some embodiments, the wafers formed by the embodiments of the present invention may be diced in semiconductor chip form. The resulting semiconductor chips can be distributed by the fabricator in raw wafer form (that is, as a single wafer that has multiple unpackaged chips), as a bare die or in a packaged form. In the latter case, the chip is mounted in a single chip package (such as a plastic carrier, with lead that is affixed to a motherboard or other higher level carrier) or in a multichip package (such as a ceramic carrier that has either or both surface interconnections or buried interconnections). In any case the chip is then integrated with other chips, discreet circuit elements, motherboard or end product. The end product can be any product that includes integrated circuit chips, ranging from toys and other low-end applications to advanced computer products having a display, a keyboard or other input device and a central processor.

References in the specification to “one embodiment”, “other embodiment”, “another embodiment”, “an embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure, or characteristic is described in connection with an embodiment, it is understood that it is within the knowledge of one skilled in the art to affect such feature, structure or characteristic in connection with other embodiments whether or not explicitly described.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of operating a voltage pump system for a semiconductor chip, comprising:
one or more voltage pumps receiving a pair of clock signal inputs;
activating a first group of voltage pumps with a high clock signal level;
activating a second group of voltage pumps with a low clock signal level;
deriving the pair of clock signal inputs from an oscillator and a hold circuit; and
configuring a current clock signal output level to latch upon receipt of a hold signal.

2. The method of claim 1, wherein the hold signal is determined by a voltage regulator.

3. The method of claim 2, further comprises:
generating the hold signal when a boost voltage is equal to a reference voltage; and
generating a low level hold signal when the boost voltage is less than the reference voltage.

4. The method of claim 1, wherein the oscillator runs at a 2× frequency.

5. The method of claim 1, wherein the hold circuit further comprises:
dividing an oscillator signal input to generate the pair of clock signal inputs running at one half of a frequency of the oscillator;
configuring the pair of clock signal inputs at 180 degrees out of phase;
receiving the hold signal from a voltage regulator; and
latching the pair of clock signal inputs at the current clock signal output level, in response to receiving the hold signal.

6. The method of claim 5, wherein latching the pair of clock signal inputs at the current clock signal output level of the voltage pump system disables the one or more voltage pumps in the voltage pump system preventing voltage pump activation of further pump strokes.

7. The method of claim 1, wherein the pair of clock signal inputs are configured from the oscillator signal input by a flip flop circuit.

8. The method of claim 1, further comprising:
configuring the hold circuit to toggle the pair of clock signal inputs when the hold signal is not received; and
outputting the pair of clock signal inputs at 180 degrees out of phase to the voltage pump system.

9. The method of claim 8, further comprising:
receiving the pair of clock signal inputs and, in response, producing two voltage pump control signals for each clock signal input wherein one half of the two voltage pump control signals for each clock signal are at a high level in a first 180 degree cycle and a second half of the two voltage pump control signals are at a low level for a second 180 degree cycle for each clock signal.

10. The method of claim 1, wherein a four phase voltage pump system is configured to the oscillator and the hold circuit.

11. The method of claim 1, wherein the oscillator runs at 2 GHz.

12. The method of claim 1, wherein the pair of clock signals run at 1 GHz.

13. A multiple phase voltage pump system comprising:
a four phase voltage pump system;
a 2× frequency oscillator having a pair of oscillator signals 180-degrees out of phase;
the pair of oscillator signals coupled to a pair of divide by two D-latch circuits;
the pair of divide by two D-latch circuits each output a clock signal to a pair of pump phase generators;
the pair of pump phase generators produce four 1× frequency clock signals;
the four 1× frequency clocks signals at 90 degrees out of phase with each other;
a voltage regulator determining a hold signal; and
one or more voltage pumps each having a voltage pump activation state and a voltage pump disable state; and wherein the pump disable state occurs when the voltage regulator determines a high level hold signal.

14. The multiple phase voltage pump system of claim 13, further comprises a current clock signal level that is latched when the hold signal is received from the pair of hold circuits and disabling the voltage pumps to maintain their present level and the current clock signal level that is toggled when a low level hold signal is received from the pair of hold circuits activating voltage pump state to boost a voltage level.

15. The multiple phase voltage system of claim 13, wherein the D-latch circuits use a flip flop circuit with a toggle/hold function.

16. The multiple phase voltage system of claim 13, wherein the four 1× frequency clock signals at 90 degrees out of phase further comprises the four phase voltage pump system wherein the one or more voltage pumps activate to provide a pump stroke every 90 degrees.

17. The multiple phase voltage system of claim 13, wherein the voltage regulator determines the high level hold signal when a boost voltage is at least equal to a reference voltage.

18. The multiple phase voltage system of claim 13, wherein the high level hold signal received by the two D-latch circuits latches a current clock signal level for the four 1× frequency clocks and prevents further pump strokes of the one or more voltage pumps when the voltage pump is in the voltage pump disable state.

19. The multiple phase voltage system of claim 13, wherein a low level hold signal is received by the two D-latch circuits, and the two D-latch circuits toggle a current clock signal level for the four 1× frequency clock signals creating a voltage pump activation state.

20. The multiple phase voltage system of claim 19, wherein the two D-latch circuits toggle the current clock signal level for the four 1× frequency clock signals until the high level hold signal is determined.
